(19) United States
(12) Patent Application Publication
(10) Pub. No.: US 2003/0022684 A1
(43) Pub. Date: Jan. 30, 2003

(54) System, method and device for warning notification

(76) Inventor: Stephen C. Seeger, Tampa, FL (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/263,916

(22) Filed: Oct. 3, 2002

Related U.S. Application Data
(63) Continuation-in-part of application No. 09/496,553, filed on Feb. 2, 2000.
(60) Provisional application No. 60/118,423, filed on Feb. 2, 1999.

(51) Int. Cl. H04B 7/00; H04M 11/00; H04Q 7/20

(52) U.S. Cl. 455/521; 455/404

(57) ABSTRACT

A system, method and device for enabling an individual, positioned at a location wherein radio and/or television signals are unavailable and/or unreliable, to be alerted to a potential threat, and/or to enabling an individual positioned in a first location to be advised of a noteworthy situation in a second location of interest, such as the area of a child's school or a geographically related industrial or military complex having a chemical, nuclear, biological material and/or any other type of emergency, thereby enabling an individual to take appropriate action to prevent potential loss of property and/or life.

### CROSS-REFERENCE TO RELATED APPLICATIONS

To the full extent permitted by law, the present application claims priority to and the benefit of the following applications: 1) as a continuation-in-part application of non-provisional application entitled “Method and Apparatus for Receiving and Transmitting Radio Signals” filed on Feb. 2, 2000, having assigned U.S. patent application Ser. No. 09/496,553, which claims priority to provisional application filed on Feb. 2, 1999, having assigned U.S. patent application Ser. No. 60/118,423, wherein both above applications are incorporated herein by reference.

### TECHNICAL FIELD

The present invention relates generally to warning notification methods and, more specifically, to a system, method and device for warning notification, wherein broadcast alerts such as National Oceanographic and Atmospheric Administration (NOAA) warnings incorporating Specific Area Message Encoding (SAME) technology are monitored and utilized to enable notification of individuals via at least one proactive means of communication such as, for exemplary purposes only, a telephone, a digital, cellular or other wireless communicator and/or an electronic or digital messaging system. The present invention is particularly suited for, although not limited to, enabling an individual positioned at a remote location, wherein traditional radio signals are unreliable, to be alerted to a potential threat thereby enabling an individual to take appropriate action to prevent potential loss of property and/or life.

### BACKGROUND OF THE INVENTION

Almost 50 years ago, the National Weather Service, under the auspices of the United States Department of Commerce's National Oceanic and Atmospheric Administration (NOAA), began development of a voice radio broadcast system for specialized weather information. This early system relied upon commercial radio and television services for public broadcast of weather alerts and was generally only functional in large and/or coastal cities.

Generally, a National Weather Service representative would record a series of voice messages. The messages would then be selected for play to correspond with the weather conditions and/or time of day. Modern systems have replaced such tapes with digitized files, whereby computer management of the process is enabled. However, the basic transmission/reception concept has remained the same. That is, commercially owned towers are utilized to hold transmitters that are linked into the computer management system via telephone lines, microwave or ultra-high frequency links.

The Warning Alert Tone (WAT) was developed as a specific tonal signal, at 1050 Hz, to be broadcast prior to any warning-type broadcast. Ultimately, the WAT became the Emergency Broadcast System, wherein any type of potentially disastrous weather, attack or national emergency could be reported. What followed was development of the specialized signal enabled devices, now commonly known as weather radios. With such devices the radio is actively monitoring announcements and no sound is generated until the appropriate signal is received, wherein no action is necessary on the part of the user in order to activate reception of an incoming alert.

While the combined National Weather Radio (NWR) and EBS systems were generally effective, technological advances and population growth precipitated the development of the NWR Specific Area Message Encoding (SAME). The SAME technique enables the broadcast alerts to be geographically specific, that is, each microprocessor signal includes codes at the beginning and end of each message, whereby software can automatically select and distribute the messages. Self-described applications for the NWR SAME system include overriding cable television systems, interrupting music services, and automatically turning on a muted speaker in response to a given threat.

This type of system can be successful if an individual is watching television, listening to music, or has a special weather-type radio located within a reception area. However, for individuals in a remote location or otherwise in a position of general communication isolation or not proximate to a television or radio, the present system is disadvantageous and does not provide adequate protection.

Therefore, it is readily apparent that there is a need for a system, method and device for warning notification, wherein broadcast alerts such as NOAA warnings incorporating SAME technology or other similar technologies are monitored and utilized to enable notification of individuals via at least one proactive means of communication such as, for exemplary purposes only, a telephone, a digital, cellular or other wireless communicator and/or an electronic or digital messaging system, thus preventing the above-discussed disadvantages.

### BRIEF SUMMARY OF THE INVENTION

Briefly described, in a preferred embodiment, the present invention overcomes the above-mentioned disadvantages and meets the recognized need for such a system by providing a system, method and device for enabling an individual, positioned at a location wherein access to radio and/or television is unavailable, unreliable and/or not being utilized, to be alerted to a potential threat, and/or for enabling an individual positioned in a first location to be advised of a noteworthy situation in a second location of interest, such as the area of a child's school or a geographically related industrial or military complex having a chemical, nuclear and/or biological material emergency, thereby enabling an individual to take appropriate action to prevent potential loss of property and/or life.

According to its major aspects and broadly stated, the present invention is a system, method and device for warning notification, wherein broadcast alerts such as National Oceanographic and Atmospheric Administration (NOAA) warnings incorporating Specific Area Message Encoding (SAME) technology or other technologies are monitored and utilized to enable notification of individuals via at least one proactive means of communication such as, for exemplary purposes only, a telephone, a digital, cellular or other wireless communicator and/or an electronic or digital messaging system.

More specifically, the device of the present invention in its preferred form is a weather radio converter having a receiver tuned to appropriate broadcast frequencies for reception of NOAA NWS signals incorporating geographically discriminating SAME technology, a telephone line status interface, a storage module capable of retaining at least one telephone number, command execution circuitry, a signal generator, a call initiator and a data transmitter. Accordingly, the preferred embodiment of the present invention enables ongoing reception of NOAA NWS signals, wherein upon receipt of a message incorporating the appropriate and/or pre-selected SAME, a proactive response to alert the user to the potential emergency via the telephone is automatically initiated.

The telephone line status interface preferably assesses whether the designated line is in-use and, in response thereto, performs according to one of a plurality of subroutines, wherein the command execution circuitry, signal generator, call initiator and audible data transmitter cooperate to generate a preferably distinct ringing tone through any and/or all devices linked to the telephone line and/or to transmit an audible message to a user. User initiated and/or automated response options to the audible message preferably include generation of a first DTMF tone sequence enabling connection to a real-time broadcast from NOAA, generation of a second DTMF tone sequence to connect to a second user and/or generation of third DTMF tone sequence to initiate a series of automated message alert calls to a preprogrammed plurality of numbers, wherein the preprogrammed plurality of numbers may include any type of telephone number such as, for exemplary purposes only numbers on a public switched network, a cellular network and/or a radio pager network. Preferably, the message alert calls are multi-functionally identifiable such that the type of device that receives the message alert call establishes the response thereto. For example, a text-enabled device can receive and transmit textual message alert data to the user and/or an audible device could receive and transmit audible message alert data to the user.

Individual utilization of the system and device is preferred, however, an intermediary service provider can be included, wherein the service provider monitors the NOAA NWS broadcasts and utilizes the SAME technology to distinguish among the various types of warning signals, to identify service subscribers and select appropriate recipients for warning notification, and to disseminate the warning via utilization of communication systems such as, for exemplary purposes only, a public telephone network, a paging network, a cellular network, electronic messaging or mail system, satellite communication system or any other wired or wireless communication system. Additionally, although NOAA NWS broadcasts are the preferred signal source, it is anticipated that future homeland defense issues and/or law enforcement needs could result in expanded utilization of the 1050 Hz EBS signal and/or the designation of an additional signal or signals for specific emergency situations, wherein the system, method and device for warning device described herein could be utilized to proactively disseminate such alternate signals.

A feature and advantage of the present invention is the ability of such a system, device and method to enable monitoring of NOAA warnings and notification of an individual via at least one proactive means of communication.

Another feature and advantage of the present invention is the ability of such a system, device and method to enable monitoring of homeland defense, law enforcement warnings and/or any other type of alert and notification of an individual via at least one proactive means of communication.

Another feature and advantage of the present invention is the ability of such a system, device and method to monitor national alert frequencies and utilize a telephone to convey such an alert.

Another feature and advantage of the present invention is the ability of such a system, device and method to monitor national alert frequencies and utilize a digital communication device to convey such an alert.

Another feature and advantage of the present invention is the ability of such a system, device and method to monitor national alert frequencies and utilize a cellular communication device to convey such an alert.

Another feature and advantage of the present invention is the ability of such a system, device and method to monitor national alert frequencies and utilize a wireless communicator to convey such an alert.

Another feature and advantage of the present invention is the ability of such a system, device and method to monitor national alert frequencies and utilize a satellite receiver to convey such an alert.

Another feature and advantage of the present invention is the ability of such a system, device and method to monitor national alert frequencies and utilize a global computer network, such as the Internet, to convey such an alert.

Another feature and advantage of the present invention is the ability of such a system, device and method to monitor national alert frequencies and utilize cable receivers to convey such an alert.

Another feature and advantage of the present invention is the ability of such a system, device and method to enable an individual positioned at a remote, communicationally isolated location to be alerted to a potential threat.

Another feature and advantage of the present invention is the ability of such a system, device and method to enable an individual positioned in a first location to be advised of an alert situation in a second location.

Another feature and advantage of the present invention is the ability of such a system, device and method to enable an individual who is not watching television or listening to a radio to be advised of an alert situation.

Another feature and advantage of the present invention is the ability of such a system, device and method to enable an individual to be advised of an alert situation in an industrial or military complex having a chemical, nuclear and/or biological material emergency.

Another feature and advantage of the present invention is the ability of such a system, device and method to enable an individual to take appropriate action to prevent potential loss of property and/or life in response to an alert situation, regardless of the individual's location or accessibility to television or radio.

Another feature and advantage of the present invention is the ability of such a system, device and method to enable an individual to receive specialized weather information irrespective of the individual's geographic location.

Another feature and advantage of the present invention is the ability of such a system, device and method to provide individual notification of emergency situations without reliance on commercial radio and television services.

Another feature and advantage of the present invention is the ability of such a system, device and method to enable an individual to be apprised of the EBS tonal message without actually receiving the 1050 Hz signal.

Another feature and advantage of the present invention is the ability of such a system, device and method to enable reporting of any disastrous weather, attack or national emergency through proactive communication means, wherein an individual is not proximate to a television and/or radio.

Another feature and advantage of the present invention is the ability of such a system, device and method to utilize the SAME technique to enable specified user receipt of alert messages.

Another feature and advantage of the present invention is the ability of such a system, device and method to convey NOAA alert data via an electronic messaging system.

Another feature and advantage of the present invention is the ability of such a system, device and method to convey NOAA alert data via a digital messaging system.

Another feature and advantage of the present invention is the ability of such a system, device and method to enable an individual, positioned at a location wherein radio and/or television signals are unavailable and/or unreliable, to be alerted to a potential threat.

Another feature and advantage of the present invention is the ability of such a system, device and method to enable an individual positioned in a first location to be advised of a noteworthy situation in a second location of interest, such as the area of a child's school or the residential area of a loved one.

Another feature and advantage of the present invention is the ability of such a system, device and method to enable reception of NOAA NWS signals, wherein upon receipt of a message incorporating the appropriate and/or pre-selected SAME, a proactive response to alert the user to the potential emergency is automatically initiated.

Another feature and advantage of the present invention is the ability of such a system, device and method to receive and store a plurality of communication options whereby a user or users may be automatically contacted for distribution of an alert warning.

Another feature and advantage of the present invention is the ability of such a system, device and method to identify the receiving device and to tailor the message alert data for receipt thereby, for example, enabling a text-enabled device to receive and transmit textual message alert data to the user and/or an audible device could receive and transmit audible message alert data to the user.

Another feature and advantage of the present invention is the ability of such a system, device and method to incorporate a service provider to monitor the NOAA NWS broadcasts and notify individual subscribers.

Another feature and advantage of the present invention is the ability of such a system, device and method to incorporate a service provider to receive the NOAA NWS broadcasts, to utilize the SAME technology to distinguish among the various types of warning signals, to identify service subscribers and select appropriate recipients for warning notification, and to disseminate the warning via utilization of available communication systems.

Another feature and advantage of the present invention is the ability of such a system, device and method to enable the utilization of essentially any and/or all available modes of communication to ensure individual notification of a potentially dangerous or noteworthy situation.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a schematic view of a system and method for warning notification according to a preferred embodiment of the present invention, showing a device for individual monitoring and proactive notification generation.

FIG. 2 is a schematic view of a system and method for warning notification according to an alternate embodiment of the present invention, showing centralized service provider for monitoring and proactive notification generation.

### DETAILED DESCRIPTION OF THE PREFERRED AND CERTAIN ALTERNATE EMBODIMENTS

In describing the preferred and certain alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

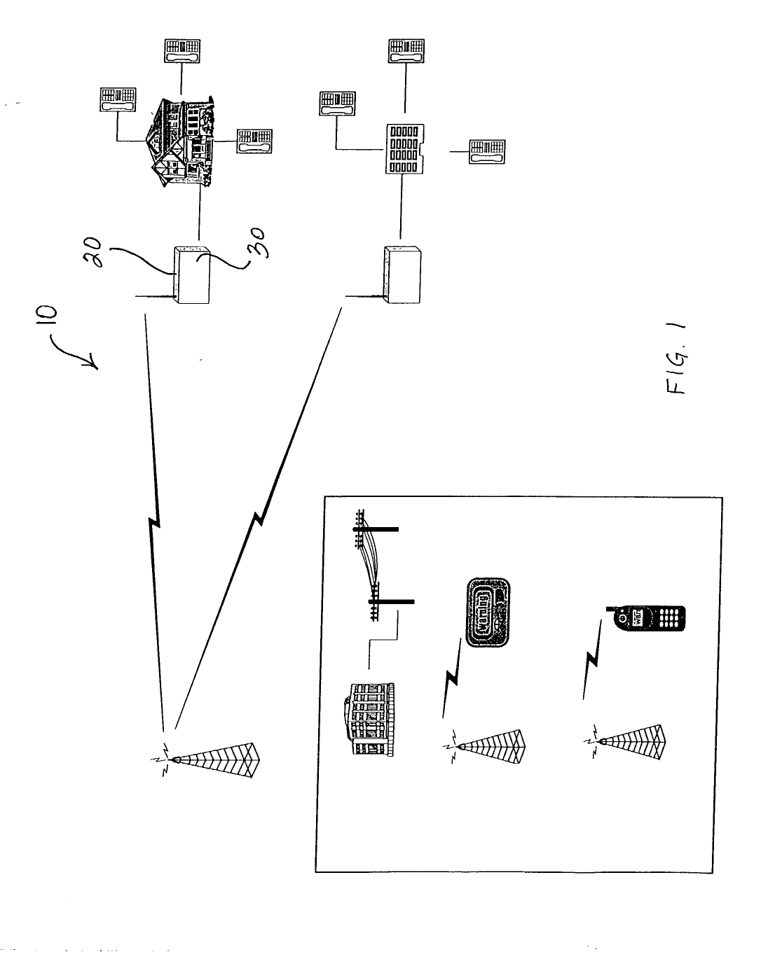

Referring now to FIG. 1, the present invention is a system, method and device for warning notification 10, preferably having weather radio converter 20 with receiver 30 tuned to appropriate broadcast frequencies for reception of National Oceanographic and Atmospheric Administration (NOAA) National Weather Service (NWS) signals incorporating geographically discriminating Specific Area Message Encoding (SAME) technology, telephone line status interface 40 (not shown), storage module 50 (not shown) capable of retaining at least one telephone number, command execution circuitry 60 (not shown), signal generator 70 (not shown), call initiator 80 (not shown) and data transmitter 90 (not shown).

Preferably, receiver 30 is a VHF FM receiver that enables selective interpretation of incoming messages' incorporating SAME, wherein geographic location and/or user input enables the selection. Receiver 30 is preferably powered via common alternating current, however, while standard electrical power is preferred, receiver 30 may be powered by other alternate sources such as, for exemplary purposes only, disposable and/or rechargeable batteries and/or may be connected to receive power via a home security system power source. Receiver 30 of weather radio converter 20 preferably enables generally ongoing reception of NOAA NWS signals, wherein receipt of a message incorporating the appropriate and/or pre-selected SAME activates telephone line status interface 40.

Telephone line status interface 40 of system, method and device for warning notification 10 preferably enables assessment of at least one pre-designated line, wherein results of said assessment enable telephone line status interface 40 to initiate at least one of a plurality of subroutines 100 (not shown). A first subroutine 102 (not shown) of plurality of subroutines 100 is initiated following assessment results indicating the telephone line is not in use, wherein first subroutine 102 preferably cooperatively utilizes command execution circuitry 60, signal generator 70 and call initiator 80 to generate a preferably distinct ringing tone through any and/or all receiving devices communicatively linked to the telephone line. Preferably, user response to the ringing tone engages audible data transmitter 90, wherein transmission of an audible warning message to the user occurs.

Preferably, storage module 50 enables at least one of a plurality of user-initiated and/or automated response options 110 to the audible message transmission from audible data transmitter 90. A first response option 112 of said plurality of user-initiated and/or automated response options 110 is preferably generation a first DTMF tone sequence, wherein connection to a real-time broadcast from NOAA is enabled. A second response option 114 of said plurality of user-initiated and/or automated response options 110 is preferably generation of a second DTMF tone sequence, wherein connection to a second user is enabled for conversation with the first user and/or subsequent transmission of the audible message. A third response option 116 of said plurality of user-initiated and/or automated response options 110 is preferably generation of a third DTMF tone sequence, wherein connection to a series of preprogrammed numbers, retrieved from storage module 50, is enabled for transmission of the audible message thereto.

Preferably, the plurality of numbers programmed within storage module 50 includes any type of telephone number such as, for exemplary purposes only, numbers on a public switched network, a cellular network and/or a radio pager network. Preferably, data transmitter 90 enables the transmission of a variety of signals, wherein the signals are multi-functionally identifiable and/or specific to the type of device that will receive the message alert call. The identification and/or specificity of the signal to the device establishes the response thereto and the format of the message received. For example, a text-enabled device receives and transmits textual message alert data to the user and/or an audible device receives and transmits audible message alert data to the user.

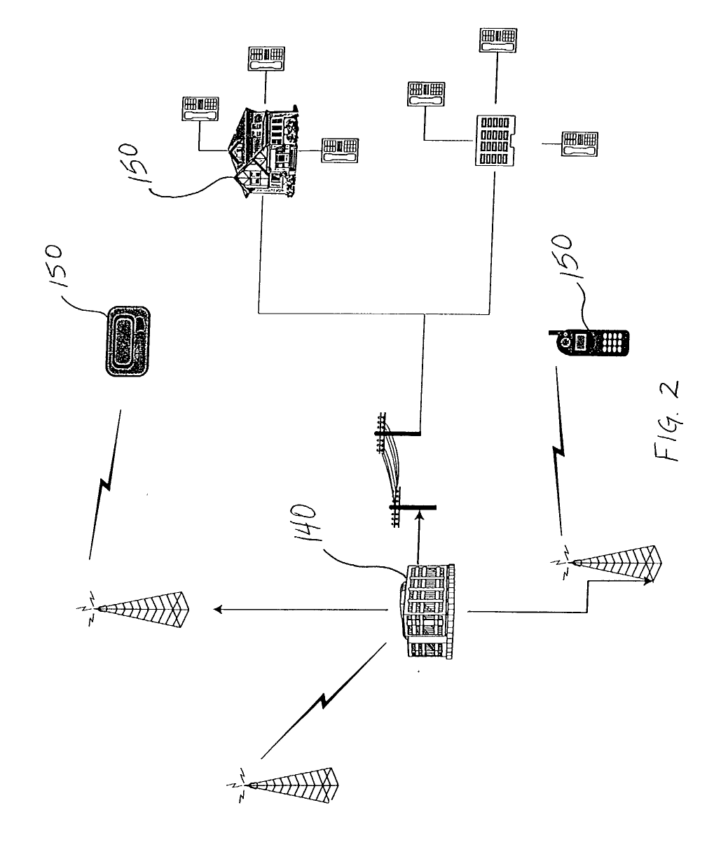

The foregoing premise based model for individual reception and utilization of the system, method and device for warning notification 10 is preferred, however in an alternate embodiment, the system, method and device for warning notification 10 incorporates service provider 140, as depicted in FIG. 2. The service provider 140 monitors the NOAA NWS broadcasts and utilizes the SAME technology to distinguish among the various types of warning signals, thus supplementing and/or replacing receiver 30 and weather radio converter 20. Service subscribers 150 provide targeted information to service provider 140, whereby service provider 140 identifies appropriate service subscribers 150 for reception of warning notification.

Warnings are proactively transmitted via service provider 140 via any appropriate means of communication such as, for exemplary purposes only, a public telephone network, a paging network, a cellular network, electronic messaging or mail system, satellite communication system and any other wired or wireless communication system. Targeted information provided by service subscribers 150 directs the selection of user-preferred communication means and/or series of communication mode attempts. For example, per a user's preprogrammed direction, a warning message could initiate a telephone call, and wherein the telephone call was unsuccessful, could initiate a page, etc. Service provider 140 could receive a return signal from a user indicating the successful receipt of the warning message, wherein subsequent attempts at communication could be aborted.

In another alternate embodiment, system, method and device for warning notification 10 could initiate an alarm via a user's home security system, wherein a fault message could be displayed to indicate the nature of the warning and/or to offer a user directions to receive additional information.

In another alternate embodiment, system, method and device for warning notification 10 could email a user with an emergency message, wherein a user's messaging system could override the user's activities to enable warning message display.

In another alternate embodiment, system, method and device for warning notification 10 could email a user with an emergency message, wherein at least one hyperlink could be provided therein to enable reception of real-time NOAA data.

In another alternate embodiment, system, method and device for warning notification 10 could email a user with an emergency message, wherein at least one data storage means could enable a user to selectively and/or automatically forward a warning message to pre-selected recipients.

In another alternate embodiment, system, method and device for warning notification 10 could receive signals and transmit warnings regarding homeland defense issues and/or law enforcements needs such as, for exemplary purposes only, a cooperative information broadcast effort in response to an “Amber Alert” situation involving a child abduction, wherein such warnings and/or alerts could be transmitted via expanded utilization of the 1050 Hz EBS signal and/or through designation of an additional signal or signals for specifically recognized emergency situations.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A system for notification, comprising:
at least one signal receiver;
a telephone line status interface, said telephone line status interface activated in response to a signal received by said at least one signal receiver and said telephone line status interface assessing at least one telephone line;
a data storage module;
command execution circuitry, said command execution circuitry commanding at least one signal generator in response to assessment data from said telephone line status interface;
at least one signal generator, said at least one signal generator initiating at least one signal in response to a command from said command execution circuitry;
at least one call initiator, said at least one call initiator receiving data from said data storage module and initiating at least one telephone transmission in response thereto; and
at least one data transmitter, said at least one data transmitter engaging in the transmission of data upon connection completion.

2. The system for notification of claim 1, wherein said at least one signal receiver comprises a weather radio converter.

3. The system for notification of claim 2, wherein said weather radio converter receives National Oceanic and Atmospheric Administration National Weather Service signals.

4. The system for notification of claim 3, wherein said National Oceanic and Atmospheric Administration National Weather Service signals incorporate Specific Area Message Encoding and wherein said data storage module enables pre-programmed, selective reception thereof.

5. The system for notification of claim 1, wherein said at least one signal receiver is a VHF FM receiver, said VHF FM receiver capable of Specific Area Message Encoding interpretation.

6. The system for notification of claim 1, wherein power for said at least one signal receiver is at least partially derived from at least one battery.

7. The system for notification of claim 1, wherein said system is electrically and communicatively linked to a security system.

8. The system for notification of claim 1, wherein said at least one telephone transmission of said at least one call initiator generates a specific ringing tone emission from a receiving device.

9. The system for notification of claim 1, wherein said data transmitted via said at least one data transmitter is an audible warning.

10. The system for notification of claim 1, wherein said data storage module enables storage of public switched telephone numbers, cellular network telephone numbers and radio pager network telephone numbers.

11. The system for notification of claim 1, wherein said data transmitter enables the transmission of multi-functional, device-identifiable signals.

12. A method for proactive warning notification, comprising the steps of:
a) obtaining a notification system and device having a signal receiver, a telephone line status interface, a data storage module, command execution circuitry, a signal generator, a call initiator, and a data transmitter;
b) receiving a warning signal via said signal receiver;
c) interfacing with a telephone line;
d) determining the status of the telephone line;
e) if the telephone line is in use, generating an interrupting signal via said signal generator;
f) if the telephone line is not in use, initiating a call via said call initiator per stored data in said data storage module;
g) completing the call connection with a user; and
h) transmitting warning data to the user.

13. The method for proactive warning notification of claim 12, further comprising the steps of:
i) generating a first DTMF tone sequence;
j) connecting the user to a National Oceanic and Atmospheric Administration broadcast.

14. The method for proactive warning notification of claim 13, further comprising the steps of:
k) generating a second DTMF tone sequence;
l) connecting the user to a second user.

15. The method for proactive warning notification of claim 14, further comprising the steps of:
m) generating a third DTMF tone sequence;
n) connecting to a plurality of preprogrammed telephone lines;
o) transmitting warning data to each connected call.

16. The method for proactive warning notification of claim 12, wherein a user receiving said call connection is a text-enabled device and wherein functional identification via said signal enables transmitting of textual warning data to the user.

17. A method for provider-based warning notification, comprising the steps of:
a) obtaining a service provider having warning signal monitoring and receiving capabilities, having Specific Area Message Encoding technology capabilities and having customer preference data storage capabilities;
p) receiving a warning signal via said signal receiver of said service provider;
q) interpreting Specific Area Message Encoding and comparing to said stored customer preference data;
r) interfacing with a telephone line of a customer per said stored customer preference data;
s) determining the status of the telephone line;
t) if the telephone line is in use, generating an interrupting signal via said signal generator;
u) if the telephone line is not in use, initiating a call via said call initiator per stored data in said data storage module;
v) completing the call connection with a user; and
w) transmitting warning data to the user.

18. The method for provider-based warning notification of claim 17, wherein a user receiving said call connection is a text-enabled device and wherein said signal transmits textual warning data.

19. The method for provider-based warning notification of claim 18, wherein said textual warning data is an electronic mail message.

20. A method of warning notification comprising the steps of:
a) receiving a warning signal;
b) generating a specific message in response to said warning signal;
c) determining a specific recipient or a specific group for receiving said warning signal;
d) transmitting said message to said specific recipient or said specific group.
